(19) United States
(12) Patent Application Publication
(10) Pub. No.: US 2019/0391804 A1
(43) Pub. Date: Dec. 26, 2019

(54) ODATA/CRUD ENABLED SOLUTION FRAMEWORK

(71) Applicant: SAP SE, Walldorf (DE)

(72) Inventor: Anbusivam S, Bengaluru (IN)

(21) Appl. No.: 16/016,929

(22) Filed: Jun. 25, 2018

(51) Int. Cl. G06F 8/70; G06F 8/60; G06F 8/35; G06F 8/36; G06Q 10/06; G06F 17/30

(52) U.S. Cl. CPC G06F 8/70; G06F 8/60; G06F 17/30345; G06F 8/36; G06Q 10/06; G06F 8/35

(57) ABSTRACT

A method includes defining a solution framework from a plurality of preconfigured components for developing a web service, defining a preliminary data model describing business objects associated with the web service, adding code that defines specific logic tasks associated with the web service, and deploying the web service utilizing the solution framework in a web server.

### BACKGROUND

Technology development and deployment projects can be very large and complex. Such systems can require many different components, for which a developer spends a significant time and effort coding. Typical software modeling systems may not be able to reduce this complexity.

Therefore, it is desired to have a framework for rapid design, development, and deployment of a project (e.g., new applications and/or services) with minimum programming and maximum reuse of software components. It is also desired to have a framework that is extensible as business usage and needs vary. Advantages include faster development times, lower development costs, and increased productivity.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a block diagram of an overall system architecture according to some embodiments.

FIG. 2 is a block diagram illustrating an exemplary framework according to some embodiments.

FIG. 3 is a flow diagram illustrating an exemplary process according to some embodiments.

FIG. 4 is a block diagram of an apparatus according to some embodiments.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The disclosed embodiments relate to software development projects including web service development, and more specifically to an ODATA/CRUD enabled solution framework infrastructure that enables rapid development of web services. Generally, the framework provides a reusable software environment that provides particular functionality as part of a larger software platform to facilitate efficient development of software applications, products, and solutions. Among other things, the software solution framework in the disclosed embodiments provides a way configure a business object model, provides a way to expose the business object model as OData without any additional coding, is CRUD-enabled by default (Create, Read, Update, and Delete), provides a standardized way to write business logic, provides transaction management and concurrency handling, and is field extensibility enabled.

The Open Data Protocol (“OData”) is a REST-based web protocol for querying and updating data. It is built on technologies such as HTTP, Atom/XML, and JSON. It provides a uniform way to describe the data and the data model. It also defines a uniform way for creating, modifying, deleting, and accessing data. OData allows a user to query a data source using a Hypertext Transfer Protocol (HTTP) and receive a result in a useable format. OData can be used to expose and access data from several types of data sources like databases, file systems, and websites. Often in a web service scenario, there is a need to expose business objects in the form of OData so that the business object can be consumed as a web service.

In some examples, the embodiments herein may be incorporated within software that is deployed on a cloud platform.

The environments described herein are merely exemplary, and it is contemplated that the techniques described may be extended to other implementation contexts.

One or more embodiments that include one or more of the advantages discussed are described in detail below with reference to the figures.

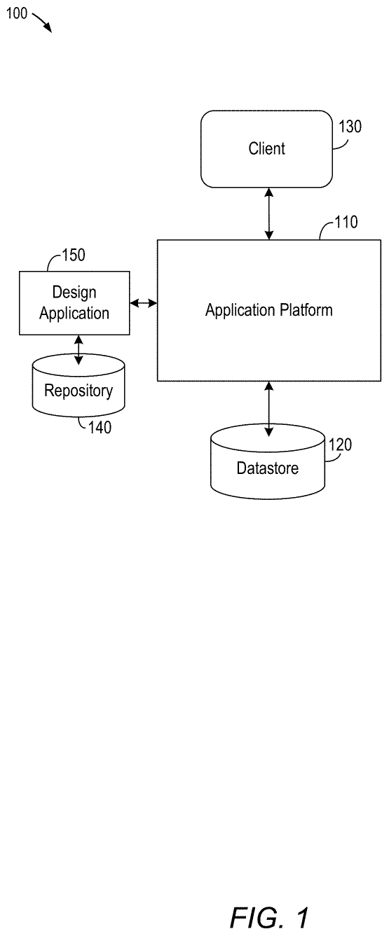

FIG. 1 is a block diagram of an overall system architecture 100 according to some embodiments. System 100 includes application platform 110, datastore 120, client 130, metadata repository 140, and design application 150. Each of the illustrated components may be implemented by software and/or one or more hardware elements, with some software and/or hardware elements being shared among more than one illustrated component.

Application platform 110 may implement a service-oriented architecture, thereby providing services (e.g., business functionality) to service consumers. Such service consumers use this business functionality to provide user interfaces, application-to-application or business-to-business integration, output management, etc. According to the illustrated embodiment, the business functionality may include retrieving, creating, modifying and/or deleting the data of business object instances stored in datastore 120. Datastore 120 may comprise any one or more systems to store business data. Such systems include, but are not limited to, relational database systems, Online Analytical Processing (OLAP) database systems, data warehouses, application servers, and flat files.

Repository 140 stores metadata defining business objects and other logical structures used by application platform 110. A developer may modify and/or create metadata within repository 140 using design application 150. Application platform 110 may create and store runtime entities based on the metadata of repository 140.

Briefly, according to some embodiments, system 100 operates to define a solution framework from a plurality of preconfigured components for developing a service, define a preliminary data model describing business objects associated with the service, add code that defines specific logic tasks associated with the service, and deploy the service utilizing the solution framework in an infrastructure. Some embodiments of the foregoing will be described in detail below.

FIG. 1 represents a logical architecture for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may comprise any number of hardware and/or software elements suitable to provide the functions described herein as well as any other functions. For example, any computing device used in an implementation of system 100 may include a processor to execute program code such that the computing device operates as described herein.

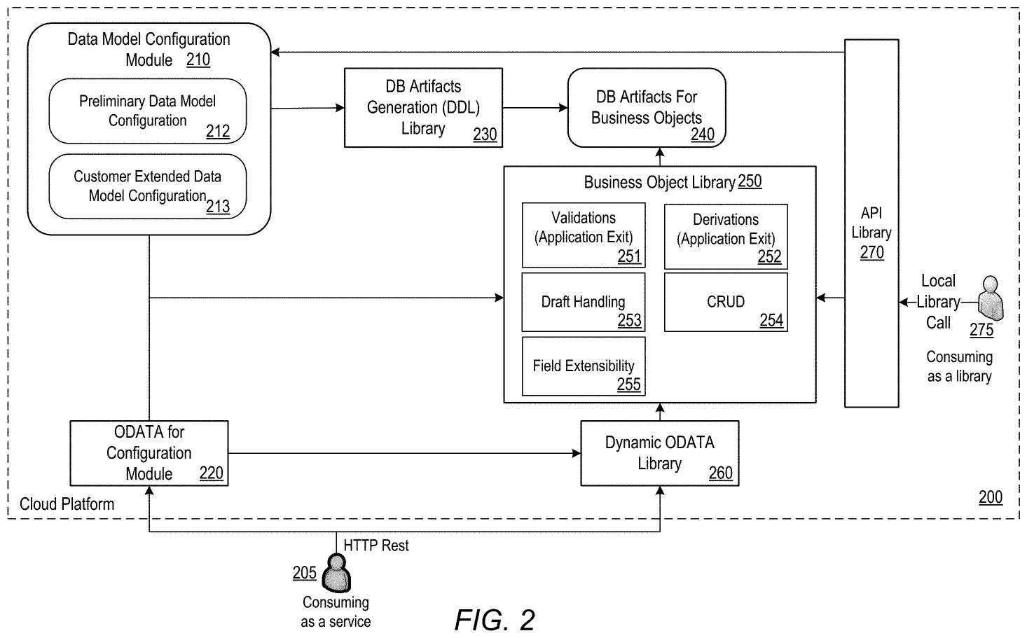

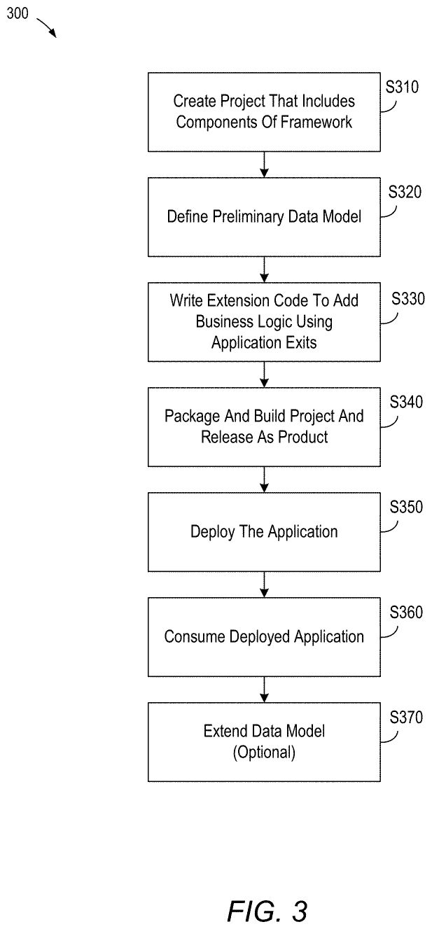

Reference is now made to FIGS. 2 and 3, which will be discussed together. FIG. 2 is a block diagram illustrating an exemplary framework 200 according to some embodiments. A framework 200 comprising a set of one or more interrelated components is provided. As shown in FIG. 2, framework 200 may comprise a data model configuration module 210, OData for data model configuration module 220, database artifacts generation library 230, business object library 250, dynamic OData library/layer 260, and API Library 270, according to some embodiments. In some embodiments, these components are predefined or preconfigured, for example, by a technology team. Design, development, and integration of various components a software project is facilitated with the components of the framework shown in FIG. 2, packaged as part of a project.

FIG. 3 is a flow diagram illustrating an exemplary process 300 according to some embodiments. More specifically, FIG. 3 is a flow diagram illustrating a process for developing an OData web service that exposes the functionalities of a business object, according to some embodiments. In some embodiments, various hardware elements of an application platform execute program code to perform process 300.

Data model configuration module 210 may comprise a configuration metadata storage which describes the structure of a business object, entities associated with a business object, attributes associated with an entity, data type and size of an attribute, a primary key of an entity, properties of the attributes (e.g., read-only, write-enabled, etc.), whether an attribute is searchable, other metadata that describes the behavior of an entity or an attribute (e.g., a field label, etc.), and/or a relationship between the entities (e.g., parent/child), etc. Additionally or alternatively, data model configuration module 210 may comprise other configuration data that is required for specific protocol requirements such as OData.

Generally, a business object is an item that represents an object within a business software system (e.g., sales order, purchase order, product master, business partner, account, etc.). A business object holds complete functionality within itself to operate as an entity. For example, a sales order business object may include all the APIs required for creating, modifying, and reading a sales order. It may also include all the business logic that is required such as validating whether all the details are correct, etc.

A business object model reflects data that is used during a given business transaction. In one embodiment, the business object may be a sales order object. However, other business objects are within the scope of this disclosure. The business object may link to the business object item (e.g., a sales order item) in order to indicate what is ordered. The business object item may indicate, for example, a Product ID, a quantity ordered (e.g., GrossAmount, NetAmount), and/or the like. The following is one simplified example of a data model structure relating to a sales order, according to some embodiments:

```
Header
  Date
  Customer ID
  Invoice Number
  Country
  Overall Price
  Item
    Product ID
    Quantity
    Unit
    Price
```

Although the foregoing depicts a few, simplified business objects, actual implementations of business objects may include hundreds if not thousands of business objects with complex associations, methods, and/or data. Moreover, each of these business objects may have entities with attributes defined by a developer.

Initially, in design time, at S310, a project is created that includes the components of framework 200, which may comprise a data model configuration module 210, OData for data model configuration module 220, database artifacts generation library 230, business object library 250, dynamic OData library/layer 260, and API Library 270.

Next, at S320, a desired data model 212 is defined using OData (e.g., outside the software, by a developer). In some embodiments, preliminary data model 212 is the definition of a business object that is delivered by a technology team within an enterprise. OData for configuration module 220 exposes the required APIs in the OData format in order to maintain the data model. Through OData for configuration module 220, the defined configuration is pushed (e.g., in the OData format) into database storage (persistency) in data model configuration 210 (e.g., updates the database), and more particularly, to preliminary data model configuration module 212.

Advantageously, framework 200 can be enhanced using one or more “application exits.” Application exits allows to extend common features in the scope of an application and its contained objects. For example, application exits are implemented to perform specific (e.g., customer-specific) logic tasks such as validations and derivations. By way of the application exits provided by business object library 250, developers can concentrate on implementing and tailoring business rules/logic for a specific application. In some embodiments, a developer need only write code at these two exit points (application exits).

Business object library 250 is a registry for function modules. Business object library 250 provides the required APIs to query, create, update, and delete the entities defined in the data model configuration. Business object library 250 exposes the exits for performing the business validations and required derivations. In some embodiments, based on the customer extended model this also allows the consumer to consume the extended entities/fields. In some embodiments, the business object library 250 offers additional functionalities such as draft handling 252 (a temporary storage until the actual transaction is committed).

Accordingly, in some embodiments, at S330, extension code may be written to add logic (e.g., business logic) for validations and derivations using application exits provided by business object library. Validations include a list of checks that are performed (e.g., each item should have a product ID, quantity should be more than zero, country-specific checks (e.g., for a particular country, certain policies apply), etc.). Derivations include calculations based on certain values (e.g., total price, calculation of discount rate, etc.).

Based on the configuration that is defined, the dynamic OData library 260 exposes the business objects using an OData API (application programming interface) which is CRUD (Create, Retrieve, Update, Delete) enabled.

Additionally or alternatively, in some embodiments, an API library 270 exposes a standard interface for consuming the business object directly for other purposes or additional purposes/functionalities. API library 270 exposes the business object functionalities in the form of local APIs. For example, if it is desired to use the business object library directly in code generation (e.g., writing a REST/SOAP endpoint, or another endpoint other than OData), developer 275 can do so via the API library 270.

At S340, upon completion of the software product in development (e.g., once the desired components have been created (packaged and built) for a given project), it may be released as a software product deliverable.

At S350, the developed service/application is deployed either by a customer (e.g., in the case of an on-premise solution) or by a service providing organization itself (e.g., in the case of a cloud solution). During deployment, the data model for configuration 210 is deployed. Also, OData for configuration 220 is deployed and available for consumer 205 to consume for data model extension 213. As part of this deployment, the software product is deployed into a web server.

During deployment, actual definition in the database is created. Database artifacts 240 are generated. Based on the preliminary data model configuration 212 (e.g., development organization or developer-delivered data model configuration), the database artifacts generation library 230 generates the actual database artifacts required. These are often database tables based on the entity definition defined in data model configuration module 210. In some implementations, deriving the artifacts can include using SQL data description language (DDL) statements, creating database tables, views and other artifacts.

Business object library 250 can read the data model configuration 210, and based on the configuration, it can read, update, delete, and/or query values/data from database artifacts 240.

Dynamic OData library 260 provides an OData endpoint (e.g., for end user/consumer 205) for the business object. Any additional endpoints written during development may also be deployed. Based on the configuration defined in the data model, the dynamic OData library dynamically builds the OData metadata and exposes the functionalities to query, create, update, and delete these entities. It exposes these functionalities in a REST endpoint based on OData protocol. The dynamic OData library also consumes the business object library to perform the actual operations on the database.

In turn, at S360, the deployed application may be consumed (e.g., by a consumer 205).

In some embodiments, the data model 210 may be extended, at S370, by adding additional fields or entities via a customer extended data model configuration module 213. In some embodiments, field extensibility module 255 allows customers to add particular attributes (e.g., under “ITEM”, a field for “shipping comments” such as “handle with care” can be added) on top of preliminary data model 212.

In a case where additional fields are required, preliminary data model 212 may be extended using the configuration OData 220, modifying the content of data model configuration 210. DDL library 230 generates and extends the database artifacts in 240. Business object library 250 can recognize the extended fields and offer CRUD 254 (create, read, update, and delete) operations for the extended model. This is not intended to be limiting, and in other examples, the framework 200 includes operations that are applicable to other desired application types. Dynamic OData library 260 for the business object can recognize the extended data model 213 and provide CRUD 254 operations for the extended model 213. The extended OData may be consumed using dynamic OData library 260.

In some embodiments, API library 270 can expose the extended data model 213. If there are any additional endpoints or UI developed by the development organization (or developer) 275, they may be consumed using API library 270.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

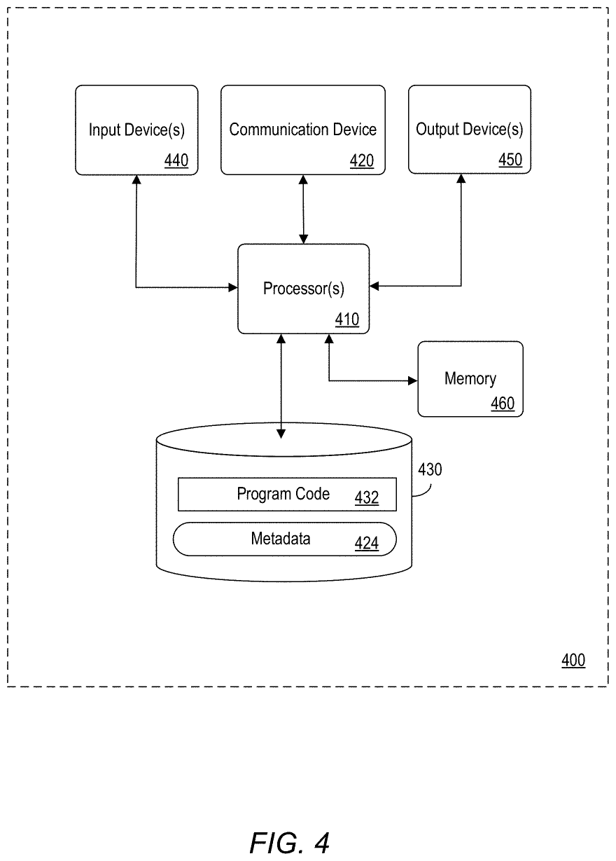

FIG. 4 is a block diagram of apparatus 400 according to some embodiments. Apparatus 400 may comprise a general- or special-purpose computing apparatus and may execute program code to perform any of the functions described herein. Apparatus 400 may comprise an implementation of one or more elements of system 100. Apparatus 400 may include other unshown elements according to some embodiments.

Apparatus 400 includes processor 410 operatively coupled to communication device 420, data storage device 430, one or more input devices 440, one or more output devices 450, and memory 460. Communication device 420 may facilitate communication with external devices, such as an external design tool. Input device(s) 440 may comprise, for example, a keyboard, a keypad, a mouse or other pointing device, a microphone, knob or a switch, an infra-red (IR) port, a docking station, and/or a touch screen. Input device(s) 440 may be used, for example, to manipulate graphical user interfaces and to input information into apparatus 400. Output device(s) 450 may comprise, for example, a display (e.g., a display screen), a speaker, and/or a printer.

Data storage device 430 may comprise any appropriate persistent storage device, including combinations of magnetic storage devices (e.g., magnetic tape, hard disk drives and flash memory), optical storage devices, Read Only Memory (ROM) devices, etc., while memory 460 may comprise Random Access Memory (RAM).

Program code 432 of data storage device 430 may be executable by processor 410 to provide functions described herein, including but not limited to process 300. Embodiments are not limited to execution of these functions by a single apparatus. Metadata 434 may include metadata of metaobjects and objects as described herein. Data storage device 430 may also store data and other program code for providing additional functionality and/or which are necessary for operation thereof, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units.

Embodiments are therefore not limited to any specific combination of hardware and software. Embodiments described herein are solely for the purpose of illustration. Those in the art will recognize other embodiments may be practiced with modifications and alterations to that described above.

1. A computer-implemented method comprising:
defining a solution framework from a plurality of preconfigured components for developing a web service, the solution framework comprising one or more application exits to extend one or more common features of an application;
defining a preliminary data model describing business objects associated with the web service;
adding code to the one or more application exits, wherein the code defines specific logic tasks associated with the web service, at least one of the specific logic tasks comprising at least one of validations and derivations; and
deploying the web service utilizing the solution framework in a web server.

2. The method of claim 1, wherein the plurality of preconfigured components comprises software modules.

3. The method of claim 2, wherein the plurality of preconfigured components includes a software module having customization parameters, and
adding code further comprises adding customization parameters for performing the validations and derivations.

4. The method of claim 3, wherein a developer need only code the customization parameters for performing the validations and derivations.

5. The method of claim 1, wherein the solution framework is Open Data Protocol (OData) enabled.

6. The method of claim 1, wherein the solution framework enables create, read, update, and delete (CRUD) operations related to data access.

7. The method of claim 1, further comprising:
consuming the deployed web service; and
extending the preliminary data model using a field extensibility mechanism provided by the solution framework.

8. A system comprising:
a processor; and
a memory in communication with the processor, the memory storing program instructions, the processor operative with the program instructions to perform the operations of:
defining a solution framework from a plurality of preconfigured components for developing a service, the solution framework comprising one or more application exits to extend one or more common features of an application;
defining a preliminary data model describing business objects associated with the service;
adding code to the one or more application exits, wherein the code defines specific logic tasks associated with the service, at least one of the specific logic tasks comprising at least one of validations and derivations; and
deploying the service utilizing the solution framework in an infrastructure.

9. The system of claim 8, wherein the plurality of preconfigured components comprises software modules.

10. The system of claim 9, wherein the plurality of preconfigured components includes a software module having customization parameters, and
adding code further comprises adding customization parameters for performing the validations and derivations.

11. The system of claim 10, wherein a developer need only code the customization parameters for performing the validations and derivations.

12. The system of claim 8, wherein the solution framework is Open Data Protocol (OData) enabled.

13. system of claim 8, wherein the solution framework enables create, read, update, and delete (CRUD) operations related to data access.

14. The system of claim 8, further comprising:
consuming the deployed service; and
extending the preliminary data model using a field extensibility mechanism provided by the solution framework.

15. A non-transitory computer readable medium having stored therein instructions that when executed cause a computer to perform a method comprising:
defining a solution framework from a plurality of preconfigured modules for developing a service, the solution framework comprising one or more application exits to extend one or more common features of an application;
defining a preliminary data model describing business objects associated with the service;
adding code to the one or more application exits, wherein the code defines specific logic tasks associated with the service, at least one of the specific logic tasks comprising at least one of validations and derivations; and
deploying the service utilizing the solution framework in an infrastructure.

16. The non-transitory computer-readable medium of claim 15, wherein the plurality of preconfigured modules includes a software module having customization parameters; and
adding code further comprises adding customization parameters for performing the validations and derivations.

17. The non-transitory computer-readable medium of claim 16, wherein a developer need only code the customization parameters for performing the validations and derivations.

18. The non-transitory computer-readable medium of claim 15, wherein the solution framework is Open Data Protocol (OData) enabled.

19. The non-transitory computer-readable medium of claim 15, wherein the solution framework enables create, read, update, and delete (CRUD) operations related to data access.

20. The non-transitory computer-readable medium of claim 15, the method further comprising:
consuming the deployed service; and
extending the preliminary data model using a field extensibility mechanism provided by the solution framework.
